(19) United States
(12) Patent Application Publication
(10) Pub. No.: US 2002/0113003 A1
(43) Pub. Date: Aug. 22, 2002

(54) Blood collection systems including a flexible filter with a cushioned periphery

(75) Inventors: Daniel R. Lynn, Spring Grove, IL (US); Allen R. Wons, Antioch, IL (US); Gregory Maurice Soudant, Wodecq (BE); Daniel Gaston Vandendaul, Lens (BE); Luc Joseph Andre Mespreuve, Ath (BE)

Correspondence Address: RYAN KROMHOLZ & MANION, S.C., Post Office Box 26618, Milwaukee, WI, 53226, US

(73) Assignee: Baxter International, Inc.

(21) Appl. No.: 09/920,203

(22) Filed: Aug. 1, 2001

Related U.S. Application Data
(63) Continuation of application No. 09/579,590, filed on May 26, 2000, now abandoned.

(51) Int. Cl. B01D 35/00

(52) U.S. Cl. 210/257.1; 210/435

(57) ABSTRACT

A blood collection system has a container for holding blood, and a filter communicating with the container, which are mutually arranged for handling as a unit. The filter contains a fibrous filter medium housed within two flexible sheets of plastic. A first seal joins the sheets directly to the filter medium inboard of the peripheral edge of the filter medium, and a second seal joins the sheets outboard of the peripheral edge of the filter medium. A region of the filter medium extends between the first and second seals to cushion contact with the filter housing during handling.

### FIELD OF THE INVENTION

The invention generally relates to blood collection and processing systems and methods.

### BACKGROUND OF THE INVENTION

Systems composed of multiple, interconnected plastic bags have met widespread use and acceptance in the collection, processing and storage of blood components. Using these systems, whole blood is collected and separated into its clinical components (typically red blood cells, platelets, and plasma). The components are individually stored and used to treat a multiplicity of specific conditions and diseased states.

Before storing blood components for later transfusion, it is believed to be desirable to minimize the presence of impurities or other materials that may cause undesired side effects in the recipient. For example, because of possible febrile reactions, it is generally considered desirable to remove substantially all the leukocytes from blood components before storage, or at least before transfusion.

Filtration is conventionally used to accomplish leuko-reduction. Systems and methods for reducing the number of leukocytes by filtration in multiple blood bag configurations are described, e.g., in Stewart U.S. Pat. No. 4,997,577, Stewart et al. U.S. Pat. No. 5,128,048, Johnson et al. U.S. Pat. No. 5,180,504, and Bellotti et. al. U.S. Pat. No. 5,527,472.

### SUMMARY OF THE INVENTION

The invention provides a blood collection system comprising a container for holding blood, and a filter communicating with the container. The container and filter are mutually arranged for handling as a unit. The filter contains a fibrous filter medium housed within two flexible sheets of plastic. A first seal joins the sheets directly to the filter medium inboard of the peripheral edge of the filter medium, and a second seal joins the sheets outboard of the peripheral edge of the filter medium. A region of the filter medium extends between the first and second seals to cushion contact with the filter housing during handling.

Other features and advantages of the invention will become apparent upon review of the following description, drawings, and appended claims.

### BRIEF DESCRIPTION OF THE DRAWINGS

FIG. 1 is a schematic view of a blood collection and storage system that includes an integral flexible filter that removes leukocytes from red blood cells;

FIG. 2 is top view of the integral flexible filter that forms a part of the system shown in FIG. 1;

FIG. 3 is a side section view of the filter shown in FIG. 2, taken generally along line 3-3 in FIG. 2. an assembled perspective view of the integral flexible filter shown in FIG. 2; and

FIG. 4 is an exploded perspective view of the filter shown in FIG. 2, showing the assembly of a molded port to the filter.

The invention is not limited to the details of the construction and the arrangements of parts set forth in the following description or shown in the drawings. The invention can be practiced in other embodiments and in various other ways. The terminology and phrases are used for description and should not be regarded as limiting.

### DESCRIPTION OF THE PREFERRED EMBODIMENTS

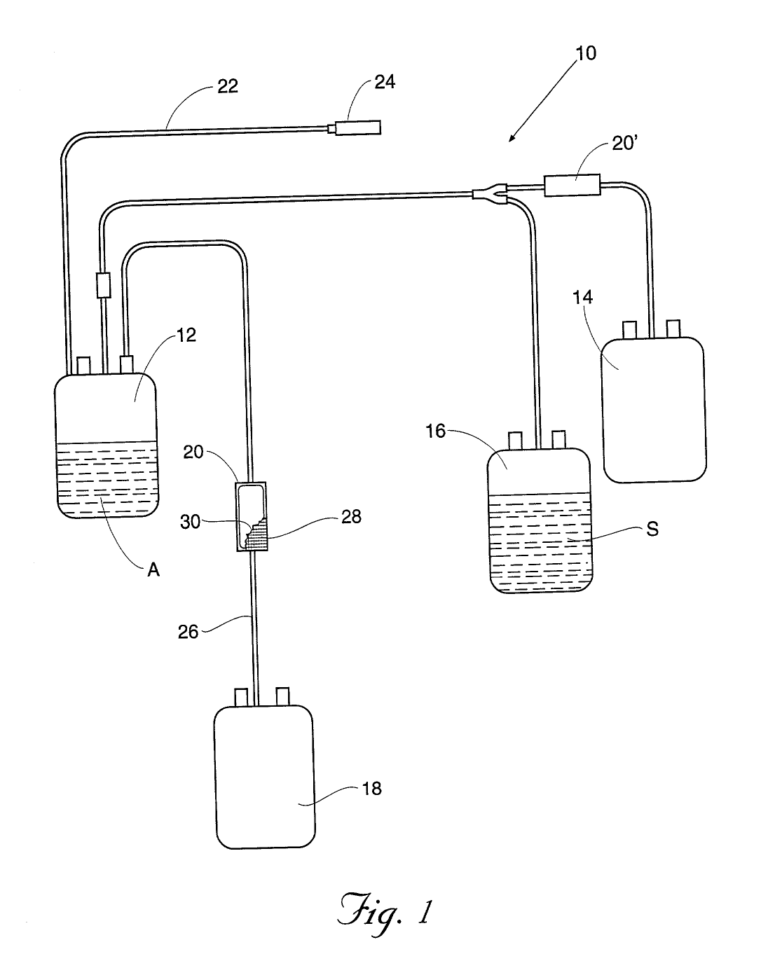

FIG. 1 shows a manual blood collection and storage system 10 having an integral flexible filter 20, which are arranged for handling as a unit. The system 10 provides red blood cells for long term storage that are substantially free of leukocytes. The system 10 also provides platelet concentrate and the platelet-poor plasma for long term storage. The blood collection and storage assembly 10, once sterilized, constitutes a sterile, “closed” system, as judged by the applicable standards in the United States. The system 10 is a disposable, single use item.

As shown in FIG. 1, the system 10 includes a primary bag 12 and three transfer bags or containers 14, 16, and 18. Like the flexible filter 20, the transfer bags 14, 16, and 18 are integrally attached to the system 10.

In use, the system 10 is handled in conventional ways. The primary bag 12 (which is also called a donor bag) receives whole blood from a donor through integrally attached donor tube 22 that carries an phlebotomy needle 24. A suitable anticoagulant A is contained in the primary bag 12. The system 10, with attached filter 20, is placed into a bucket of a centrifuge (not shown). The entire system 10, with attached filter, is spun within the centrifuge bucket. Whole blood is centrifugally separated inside the primary bag 12 into red blood cells and platelet-rich plasma. Leukocytes dwell in the interface between the red blood cells and platelet-rich plasma.

The transfer bag 14 is intended to receive platelet-rich plasma separated from the whole blood collected in the primary bag 12. Attempts are made when transferring the platelet-rich plasma out of the primary bag 12 to keep as many leukocytes in the primary bag 12 as possible. The transfer of platelet-rich plasma into the transfer bag 14 leaves the red blood cells and the leukocytes behind in the primary bag 12.

The transfer bag 16 contains a suitable storage solution S for red blood cells. One such solution is disclosed in Grode et al U.S. Pat. No. 4,267,269, which is sold by Baxter Healthcare Corporation under the brand name ADSOL® Solution. The storage solution S is transferred into the primary bag 12 after transfer of the platelet-rich plasma into the transfer bag 14.

The platelet-rich plasma is centrifugally separated by conventional means in the transfer bag 14 into platelet concentrate and platelet-poor plasma. The platelet-poor plasma is transferred into the transfer bag 16, which is now emptied of storage solution S. The transfer bag 16 serves as the storage container for the platelet-poor plasma. The transfer bag 14 serves as its storage container for the platelet concentrate.

The storage solution S is mixed with the red blood cells and leukocytes remaining in the primary bag 12. The mixture of storage solution S, red blood cells, and leukocytes is transferred from the primary bag 12 through tubing 26.

The tubing 26 carries in-line the integral, flexible filter 20. The flexible filter 20 includes a filtration medium 28 contained within a housing 30. The filtration medium is selected to remove leukocytes from red blood cells. The filter 20, being flexible, facilitates handling and reduces the incidence of damage to other flexible plastic components of the system 10 during centrifugal processing.

The leukocyte-reduced red blood cells enter the transfer bag 18. The transfer bag 18 serves as the storage container for the leukocyte-reduced red blood cells.

The bags and tubing associated with the processing system 10 can all be made from conventional approved medical grade plastic materials, such as polyvinyl chloride plasticized with di-2-ethylhexyl-phthalate (PVC-DEHP). The bags are formed using conventional heat sealing technologies, e.g., radio frequency (RF) heat sealing.

Alternatively, since the transfer bag 14 is intended to store the platelet concentrate, it can be made of polyolefin material (as disclosed in Gajewski et al U.S. Pat. No. 4,140,162) or a polyvinyl chloride material plasticized with tri-2-ethylhexyl trimellitate (TEHTM). These materials, when compared to DEHP-plasticized polyvinyl chloride materials, have greater gas permeability that is beneficial for platelet storage.

The flexible filter 20 includes a filter housing 30 comprising first and second sheets 32 and 34 of flexible, medical grade plastic material, such as polyvinyl chloride plasticized with di-2-ethylhexyl-phthalate (PVC-DEHP). Other medical grade plastic materials can be used that are not PVC and/or are DEHP-free.

The filtration medium 28 is made from a fibrous material, which is sandwiched between the sheets 32 and 34. The filtration medium 28 can be arranged in a single layer or in a multiple layer stack. The medium 28 can include melt blown or spun bonded synthetic fibers (e.g., nylon or polyester or polyethylene or polypropylene), semi-synthetic fibers, regenerated fibers, or inorganic fibers. In use, the medium 28 removes leukocytes by depth filtration.

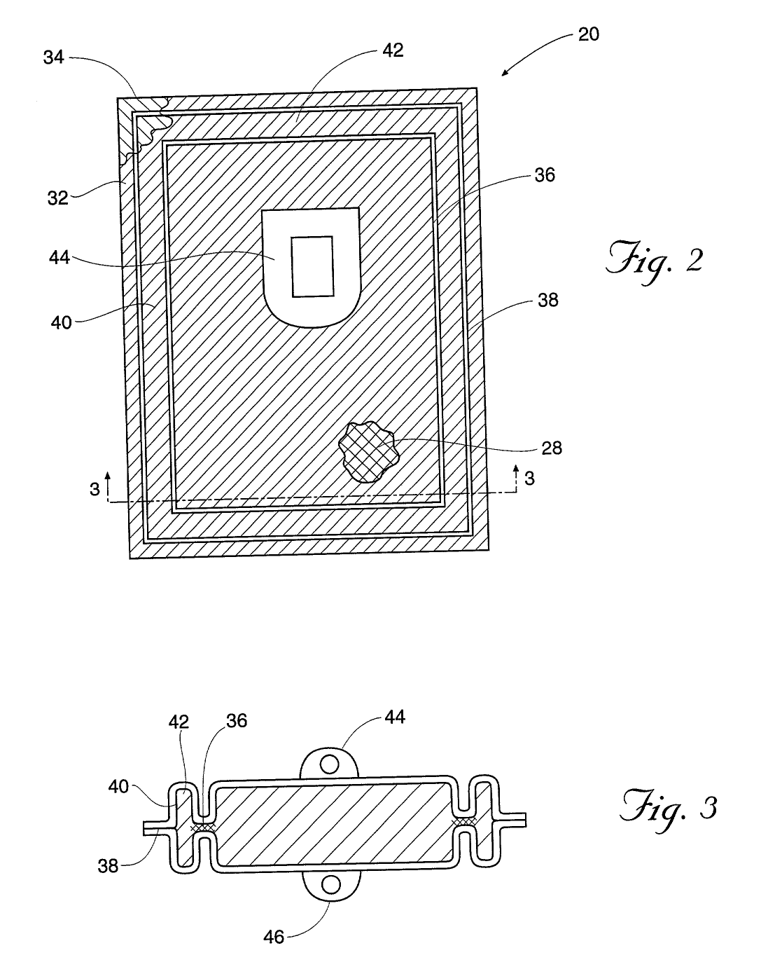

According to the invention (see FIGS. 2 and 3), the filter 20 includes an inboard main seal 36 and an outboard secondary seal 38. The main seal 36 joins the two sheets 32 and 34 to each other, as well as joins the filtration medium 28 to the two sheets 32 and 34. The secondary seal 38 is spaced outboard of the peripheral edge 40 of the filtration medium 28 and joins just the two sheets 32 and 34 to each other.

As a result of this construction, a region 42 of filtration medium 28 extends between the main seal 36 and the secondary seal 38. The region 42 provides a “soft” periphery or “cushion” about the filter 20. The cushioned periphery provides enhanced protection against damage to tubing and bags of the system 10 when the bags, tubing and filter are handled as a unit, e.g., when centrifuged in the same centrifuge bucket. The combination of the main seal 36 inboard of the filtration medium 28 and the secondary seal 38 outboard of the filtration medium 28 also prevents edge flow and provides duplicate seal protection against leaks.

The main seal 36 can be formed by the application of pressure and radio frequency heating to the two sheets 32 and 34 and filtration medium 28. The secondary seal 38 can likewise be formed by the application of pressure and radio frequency heating to the two sheets 32 and 34. The main seal 36 and secondary seal 38 can be formed in sequential heat sealing processes, or simultaneously in a single heat sealing process.

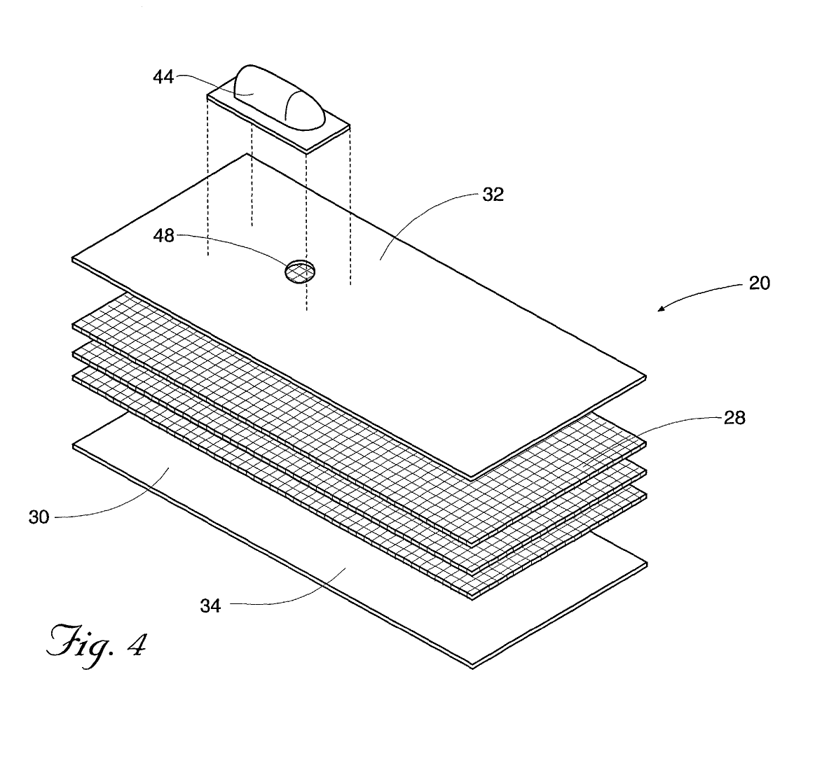

The filter 20 also includes inlet and outlet ports 44 and 46. As FIG. 4 shows, the ports 44 and 46 comprise separately molded parts that are heat sealed by radio frequency energy over a hole 48 formed in the sheets 32 and 34, preferably before the main seal 36 and secondary seal 38 are created.

A flexible filter 20′ (shown in phantom lines in FIG. 1) can be also be integrated into a multiple blood bag system in-line between the primary bag 12 and the transfer bag 14. In this arrangement, the filtration medium 28 is selected to remove leukocytes from platelet-poor plasma prior to entering the transfer bag 14.

Various features of the invention are set forth in the following claims.

We claim:

1. A blood collection system comprising
a container for holding blood, and
a filter communicating with the container, the container and filter being mutually arranged for handling as a unit, the filter comprising a fibrous filter medium having a peripheral edge, a housing comprising two flexible sheets enveloping the filter medium, a first seal joining the sheets directly to the filter medium inboard of the peripheral edge of the filter medium, a second seal joining the sheets outboard of the peripheral edge of the filter medium, a region of the filter medium extending between the first and second seals to cushion contact with the filter housing during handling.

2. A system according to claim 1
wherein the filter medium removes leukocytes from blood.

3. A system according to claim 1
wherein the filter is integrally connected by tubing to the container.
